(19) United States
(12) Patent Application Publication
(10) Pub. No.: US 2010/0046887 A1
(43) Pub. Date: Feb. 25, 2010

(54) Optical Fibre Transmission

(75) Inventors: Ian Hugh White, Cambridge (GB); Richard Vincent Penty, Cambridge (GB); David Gareth Parker, Cambridge (GB)

Correspondence Address: GOODWIN PROCTER LLP;PATENT ADMINISTRATOR, 53 STATE STREET, EXCHANGE PLACE, BOSTON, MA, 02109-2881, US

(73) Assignee: Zinwave Limited, London (GB)

(21) Appl. No.: 12/442,678

(22) PCT Filed: Sep. 26, 2007
(86) PCT No.: PCT/GB07/03671

§ 371 Date: Oct. 29, 2009

(30) Foreign Application Priority Data
Sep. 26, 2006 (GB) 0618941.9

(51) Int. Cl. G02B 6/42; G02B 6/38

(52) U.S. Cl. 385/28; 385/55

(57) ABSTRACT

Optical radiation is applied to a multimode optical fibre, either from another fibre or from a laser, in such a way as to control the mode distribution in the multimode optical fibre. The mode distribution is selected in such a way as to improve performance, for example to avoid transmission nulls or to reduce noise due to reflections back to a laser.

The present invention relates to the field of transmission of light in optical fibres, and more specifically in multimode optical fibres. More particularly but not exclusively the invention concerns a connector device for optical fibres, an optical fibre transmission system and a method of setting up an optical fibre transmission system.

Light propagating down multimode fibre can travel along a number of paths. Only a fixed number of paths down the fibre are low loss, light travelling any other route is rapidly absorbed and lost. These low loss paths are referred to as modes.

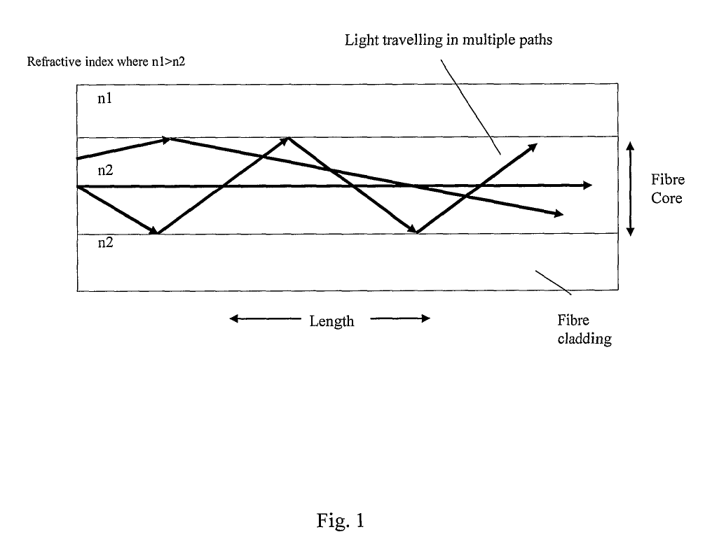

Fibre with a 62.5 μm core has 18 groups of modes. Since each mode travels a different path and therefore a different distance, each will arrive at the other end of the fibre at different times—see FIG. 1. For minimum dispersion, and hence minimum signal distortion and maximum achievable transmission rates, all the light input to one end of the fibre needs to arrive at the other end with the minimum range of delays.

Graded-Index fibre was developed to try to minimise the range of these modal time delays.

The speed at which light travels within a medium is dependent upon the refractive index of the medium. The concept of Graded Index fibre is that by varying the refractive index along the radius of the fibre the light travelling the shortest path can be made to travel slowest and light travelling the longest path fastest, such that all the light arrives at the same time.

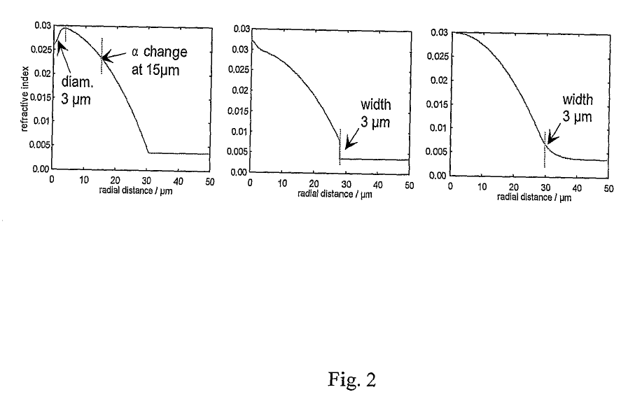

Hence the optimum refractive index profile gives the highest bandwidth. However, in practice Graded-Index fibres are known to have refractive index profiles which deviate from the optimum due to the fabrication process—see FIG. 2. These imperfections result in time delays between modes and beating of these delayed modes at the output of the fibre results in signal loss and distortion, particularly at high frequencies.

Delay in the time domain is equivalent to signal loss at higher frequencies in the frequency domain. In analog systems—i.e. systems where amplitude and/or phase information needs to be retained—the strength and quality of the received signal determines the link performance.

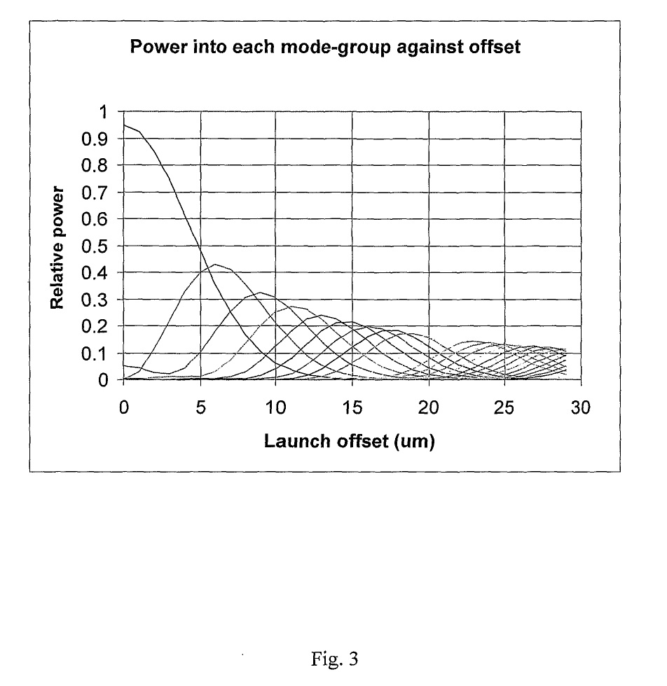

When coupling light into multimode fibre, the number of modes illuminated can be restricted by reducing the diameter of the beam of light—see FIG. 3. Often single mode fibre is used to launch the light which narrows the input beam diameter to ˜8 μm. Alternatively laser launches can also be used to restrict the number of modes illuminated. The benefit of reducing the number of modes is that this also restricts the number of potential time delays. Offsetting a restricted launch from the centre of the fibre is one way that can also allow selection of which groups of modes are excited, this allowing control of the delay between the modes and hence the distortion experienced by the signal. With a narrow input beam near the centre of the fibre, lower order modes are illuminated. As the beam moves away from the centre point more light is coupled into higher order modes and less into the lower order modes. Other ways of selecting mode groups include angled launch, controlling polarisation state, and use of a diffractive element between input device, for example fibre or laser, and the transmission fibre.

It was mentioned previously that the performance of graded index fibre is limited by the defects within the refractive index profile. These defects occur at different points along the radial axis. By controlling where along the radial axis light is launched it is possible to avoid the worst of these defects.

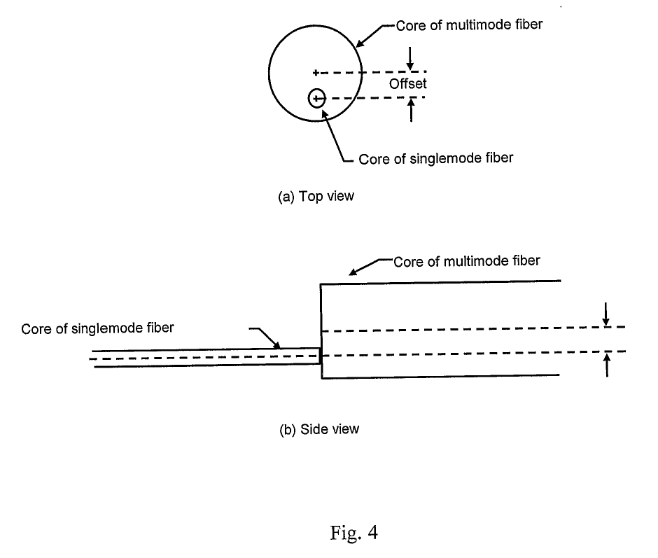

The plot of FIG. 3 shows how a small number of mode groups can be selected by varying the launch offset. An offset launch patch cord may be used to restrict where the light gets launched into multi-mode fibre—see FIG. 4.

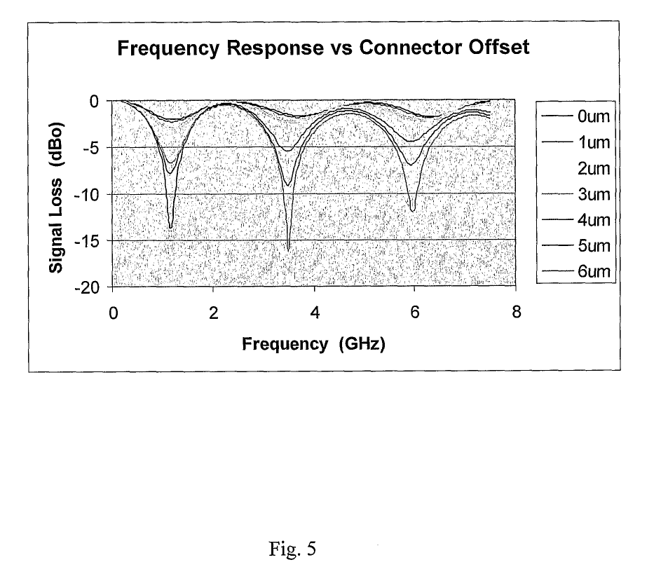

Since analog systems only require specific range of frequencies it is possible to operate in regions of low signal loss even if the general broadband loss is poor. The key to reliable operation is being able to avoid the regions of large loss. Increasing the offset at a connector interface allows light to couple into higher order modes. This change in mode power distribution alters the delay between modes. FIG. 5 shows how the time delays introduced by small offsets can result in these delayed modes beating and introducing large signal loss (nulls) into the frequency response, for a particular multimode fibre refractive index profile and fibre length.

The inventors sought to address technical problems that arise in multimode fibre systems—for example in-building systems, namely making the system versatile enough to carry at least analog signals consisting of a modulating signal carried on an rf carrier, where the frequency of the carrier is relatively high. Such analog signals need to be carried over at least medium distances in order to be worthwhile. Prior to the inventors' insight that controlling the modes in the fibre, for example by providing controlled launch conditions, can give rise to reliable analog signal transfer over even legacy or pre-installed fibres, it was believed that only baseband signals could be carried. The inventors' insight has also led to the realisation that not only analog but also baseband digital signals may be capable of being robustly transferred by multimode fibre systems at the same time—so-called “multi-service transmission”. Of course the nature of the modulation and of the modulating signal are not deterministic—the modulating signal could for example be a digital signal or an analog signal; the type of modulation can be selected as desired. The invention also facilitates the transmission of r.f. signals having different r.f. carriers.

The technical problem addressed herein relates to reliable transmission of signals in real fibre systems that often, or normally, have several fibre connectors or connections (including splices, and the like). As explained below, connections between fibres are unlikely to be perfectly aligned, and a connector for launching into the fibre is also unlikely to be perfect. It has been believed that the imperfections along the fibre system due to the connectors would upset the mode patterns along the fibre system.

Two-part connectors are well known. They endeavour to provide good alignment of one fibre portion to the next, but due to variations in the size of the fibres and to the way the connectors are assembled (and as noted above) it is largely impossible to achieve perfect centre-to-centre alignment. Certain embodiments of the present invention build upon this imperfection and propose to allow the person assembling the system to try the connector in at least two different angular orientations. More generally, some fibre connectors embodying the invention have variable properties to allow a user to set the launch conditions of light in a first fibre into a second fibre.

Where the connector is of this type, it has been found that the technical problem of degradation of system performance caused by later multimode fibre connectors, and connections, that degrade fibre system transmission performance can be ameliorated.

In a general aspect the invention relates to a method of operating an optical fibre transmission system, comprising selecting a launch condition to provide a desired performance at an output of the transmission system

In another general aspect the invention relates to a method of coupling optical radiation into a multimode optical fibre portion, the method comprising varying at least one of lateral axial offset, angular axial offset and launch polarisation to influence the optical modes coupled into the optical fibre portion, so as to improve transmission through the optical fibre portion

According to a first aspect of the invention there is proposed a connector device including first and second parts configured to receive end regions of first and second portions of optical fibre to be connected together by the connector device, wherein the connector device has means for varying the coupling conditions between the first and second portions of optical fibre thereby to influence optical modes launched into the second portion of optical fibre as a result of optical radiation in the first portion of optical fibre.

The means for varying a formation configured to enable connection between a body portion of the first part and a body portion of the second part in at least two different angular dispositions.

Locating means may be provided whereby the at least two angular dispositions are set.

The locating means may comprise a key structure on one of the parts and a counterpart structure on the respective other of the parts.

The locating means may comprise a key structure on one of the parts and a structure on the respective other of the parts, the structure being configured to accept the key.

The structure may be configured to accept the key in each of the different dispositions.

The connector device may be configured to enable mutual rotation between the first and second body portions.

Means for non-rotatably securing the first and second body portions together may be provided. This means may be used after rotational adjustment has been effected.

In one family of embodiments the connector is aligned to reduce reflection back into the laser. One example of this is by providing an offset into the fibre; another is by providing an angular offset between the launching fibre and the fibre into which the launch is effected. Angularly offset launches may thus reduce noise in the laser, and hence improve system performance. They may also vary the mode distribution.

In a second aspect there is provided a method of coupling optical radiation in a first optical fibre portion into a second optical fibre portion, the method comprising varying at least one of lateral axial offset, angular axial offset and launch polarisation to influence the optical modes coupled into the second optical fibre portion, so as to improve transmission through the second optical fibre portion.

The method may be implemented in an optical fibre system in which the second optical fibre portion has a proximal end and a distal end, wherein the proximal end generally abuts an end of the first optical fibre portion and the distal end is connected to a first end of a further optical fibre portion, the method further comprising detecting optical output from a second end of the further optical fibre portion, and implementing the varying step to improve the detected optical output.

In a further aspect there is provided an optical fibre transmission system having at least one connector device in use coupling together a first portion of fibre to a second portion of fibre, wherein at least one of the first portion and second portion is multimode fibre, wherein the connector device includes first and second parts, an end of the first portion of fibre being housed in the first part and an end of the second portion of fibre being housed in the second part, wherein the first and second parts each include a respective body portion, and wherein the connector device is configured to enable connection between the first and second body portions in at least two different angular dispositions.

In a yet further aspect there is provided a method of setting up an optical fibre transmission system, the method comprising providing a connector device for coupling together a first portion of fibre to a second portion of fibre, wherein at least one of the first portion and second portion is multimode fibre, wherein the connector device includes first and second parts, an end of the first portion of fibre being housed in the first part and an end of the second portion of fibre being housed in the second part; engaging together the first and second connector parts; launching a signal into one of said first and second fibre portions; monitoring the signal received at the other of the first and second fibres with the connector parts in mutually different angular dispositions.

In a still further aspect there is provided a method of setting up an optical fibre transmission system, the method comprising varying an offset at which an input signal beam is applied to a multimode fibre; and monitoring the signal received from an output end of the multimode fibre.

In one embodiment family, the offset is an offset position. In another the offset is an offset angle.

In positional offset embodiments, the two fibres may be angularly offset. The angular offset may be fixed.

In a further aspect there is provided a method of setting up an optical fibre transmission system, the method comprising providing a connector capable of applying different polarisation states to an input beam; thereby varying the polarisation state of an input signal beam; and monitoring the signal received from an output end of the multimode fibre.

The invention will be more clearly understood after reading the following description of some embodiments and referring to the accompanying drawings, in which:

FIG. 1 is a diagrammatic presentation of modal dispersion in a multimode fibre;

FIG. 2 shows three graphs of the refractive index profile of different multimode fibres.

FIG. 3 shows the relative power into different mode groups plotted against launch offset

FIG. 4 shows the geometry of a single mode offset launch

FIG. 5 shows variation of signal loss profiles with frequency for different connector offsets

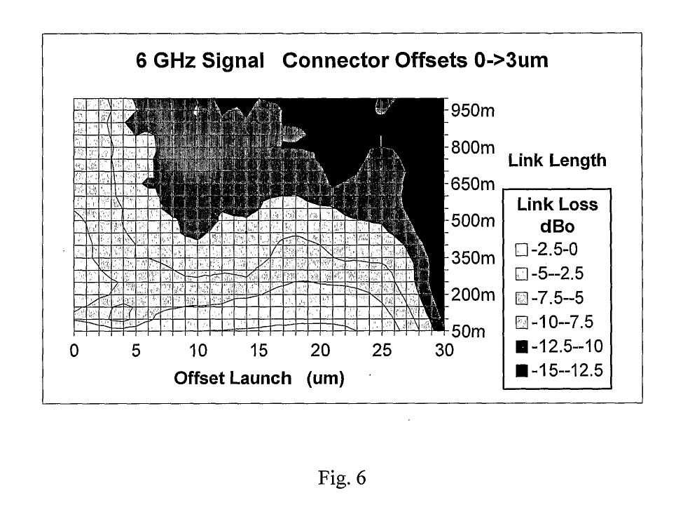

FIG. 6 shows a contour plot of expected maximum loss from 95% of deployed fibre as a function of initial launch offset and link length.

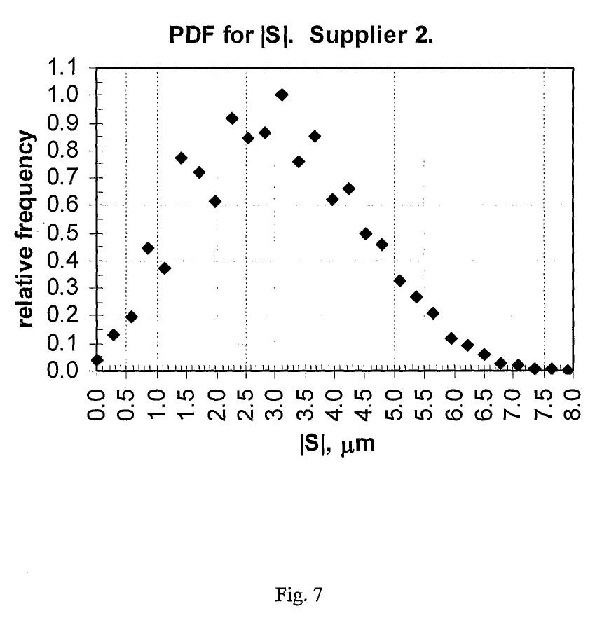

FIG. 7 shows offset S measured over a distribution of connectors.

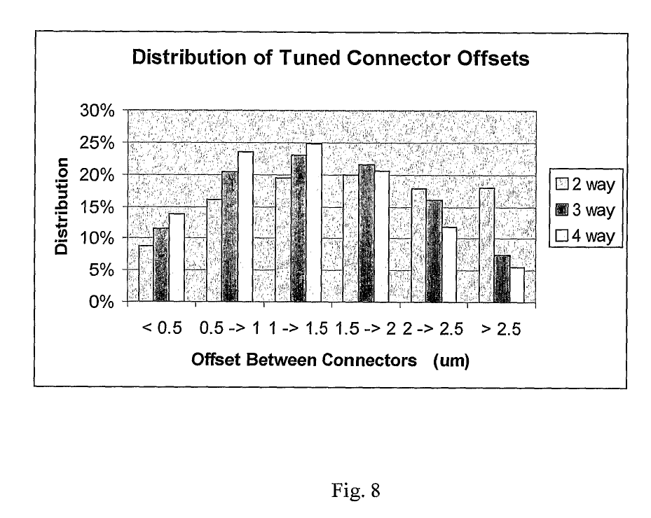

FIG. 8 shows the distribution of offsets where 180 deg rotation is afforded by the connector

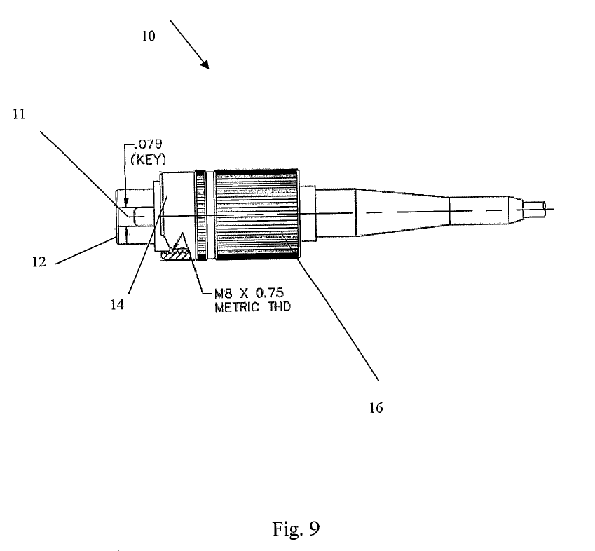

FIG. 9 shows a line drawing of an FC/PC line connector

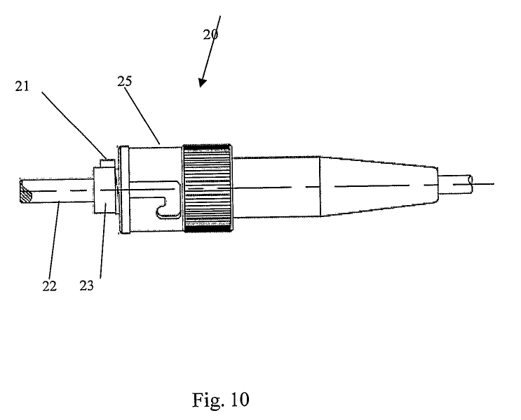

FIG. 10 shows a line drawing of an ST line connector

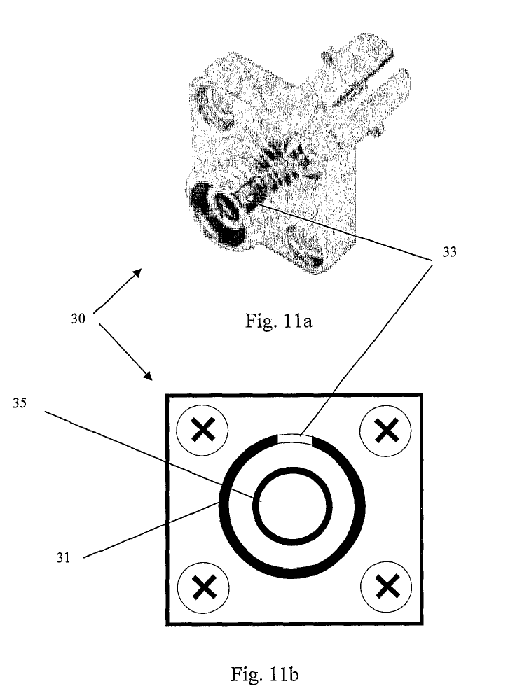

FIG. 11a shows a perspective view of a FC/PC bulkhead connector

FIG. 11b shows a line drawing of the connector of FIG. 11a;

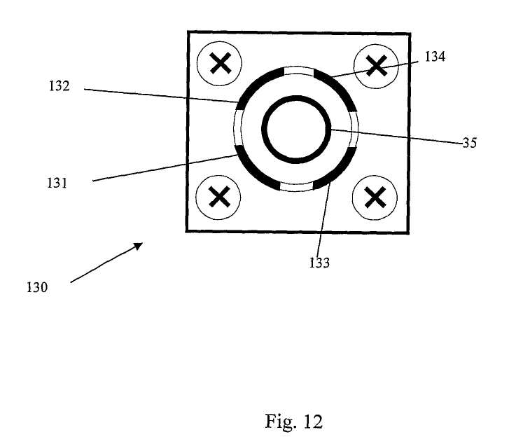

FIG. 12 shows a bulkhead connector embodying the invention; and

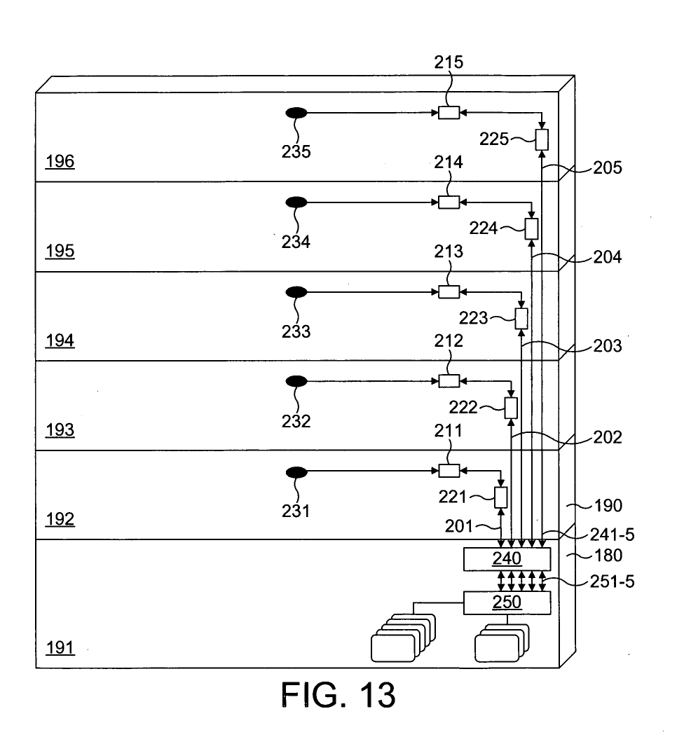

FIG. 13 shows an exemplary in-building scenario

The inventors have established that a tunable connector allows launch conditions to be varied, and that this will change the mode power profile, altering the frequency response. This allows the person tuning the connector to optimise link performance.

Without the ability to do this tuning the link loss, at the system carrier frequency, could be too big to allow transmission of the signal.

A statistical analysis of fibre variation has been carried out to estimate the reduction in signal loss due to tunable connectors. There are many variables which influence the link performance (RI profile, connector offsets, link length). These were all included in a statistical analysis to estimate the likely link loss expected in the field. FIG. 6 shows the maximum loss expected from 95% of deployed fibre. To predict how a system may perform on the fibre deployed in the field, a statistical approach must be taken. The variety of fibres expected in the field is represented by a set of 108 refractive index profiles. These profiles represent the different types of perturbation expected and the various degrees to which they occur.

This loss is shown as a function of initial launch offset and link length.

FIG. 7 shows the offset S measured over a distribution of connectors. This data was used to model how rotating a connector interface can help minimise the offset between the two fibre cores. The results, illustrated in FIG. 8, show that the offset between fibre cores is less than 3 μm if the option of 180 deg rotation (2 way keying) is possible. This distribution becomes tighter as the number of possible rotations increases. It has been shown that by reducing the connector offsets with the use of a tunable connector the narrowband link loss experienced in an analog RF system can be greatly reduced. It should also be noted that polarisation changes can cause sharp nulls in the frequency response which introduce significant loss. However dither techniques applied to a single wavelength transmitter can minimise the impact of these polarisation changes by changing the lasing wavelength. The combination of controlled connector tolerances and techniques to counter the effects of polarisation changes make it possible to implement high frequency (˜6 GHz) analog transmission on legacy multi-mode fibre.

Referring to FIG. 9, a conventional FC/PC line connector 10 has a body 14 carrying a finger grip portion 16. The connector has a forwardly-extending ferrule portion 12, that is generally an open cylinder. Inside the cylinder 12, and coaxial with it in a fibre support portion (not shown). A key 11 in the form of a finger extends forwardly alongside the ferrule portion 16.

In use, the key 11 fits into a cutout portion 33—see FIGS. 11a and 11b—of a counterpart connector 30 to ensure that the two connectors 10, 30 cannot be connected other than in one orientation. The connector 30 has a C-shaped wall 31 whose distal portions define the cut-out 33. The C-shaped wall is circular, and coaxial with a fibre-support portion 35.

Referring to FIG. 10, an ST line connector 20 has a body 25, and a fibre support portion 22 coaxial with the body. A ferrule portion 23 here carries a key 21 in the form of a tooth. Again the key 21 ensures that the two connectors cannot be connected other than in one orientation.

A connector 130 embodying one aspect of the invention is shown in FIG. 12. The connector 130 in this embodiment is similar to that shown in FIG. 11, having a circular central fibre support portion 35. Coaxial with the fibre support portion 35, and spaced outside it are four arcuate wall portions 131-4 disposed on a circular path and having ends mutually spaced apart to define four keyways therebetween. The keyways are at right angles to one another so that a conventional FC/PC line connector may be inserted at any of four angular dispositions.

Other embodiments cater for different connector types; it may be possible to have 2, 3 or more keyways.

It is also envisaged that connectors that are fully mutually rotatable may be provided (i.e. having no walls similar to 131-4 in FIG. 12). A locking mechanism is then likely to be needed so that when a “good” orientation is found, it may be retained.

To use the embodiment of FIG. 12 in setting up an optical fibre transmission system, two connectors 10, 130, each carrying a fibre portion, are engaged together. An optical signal is launched into one of the first and second fibre portions, while observing the signal received at the other of the first and second fibre portions. Then, with the connector parts in mutually different angular dispositions, the observed signal is checked to establish which is the best orientation.

It is also envisaged that tuning of a fibre alignment can be achieved by lensing light from a laser to a focused spot at a predetermined offset on the MM fibre end face. This would extend to optimisation for both centre launch and offset launch using the same technique.

A second connector allows selectable or variable amounts of angular divergence from the input into the transmitting fibre. This results in varying amounts of “mode restriction”. In one embodiment this is done by one or more lenses. In another it is achieved by diffractive elements. In yet another, electrically-controllable transmissive diffractive elements are used.

A third connector allows selectable or variable polarisation states. In one embodiment this is done by varying the polarisation angle of the input beam with respect to an arbitrary axis of the transmission fibre. A two-part connector may be provided capable of latching in different mutual positions to allow such variation. In another embodiment a phase plate or fibre equivalent may be used to provide circular or arbitrary polarisation state.

It is further envisaged that fibre alignment using a keyed connector, or rotatable alignment with locking position, may also provide specific locations to enable different mutual alignments to be provided, for instance both centre launch and offset launch conditions. The latter is of interest for over filled launch (OFL) and has application in the digital as well as analog domain.

Another way of achieving variation of lateral axial offset requires plural offset patch cords with different offsets, and testing the output signal from the transmission fibre for different such patch cords, to select the one which were tried in turn

Other techniques for varying the modes transferred from the input fibre to the transmission fibre, for example by varying the amount of offset will also be apparent to the skilled person. The invention is not restricted to controlling or influencing modes from fibre-to-fibre, but instead may also be applied to laser-to-fibre launches.

Referring to FIG. 13, a typical scenario for the use of an optical fibre transmission system is shown. In this scenario, a building 190 has a ground (or first) floor 191 and five higher storeys 192-196. In the building, fibres 201-205 are provided between a location 180 shown here on the ground floor 191, and running in a vertical riser (not shown) to respective floors of the building 190. The fibres in this embodiment are previously-installed multimode fibres. On each floor there is provided a respective telecommunications outlet 211-5, and this is connected to the respective fibre in the vertical riser at a respective connector 221-225. In some embodiments the connectors 221-225 are pluggable connectors, in others they are splices, in yet others a mixture of pluggable connectors and splices.

Further reference to FIG. 13 shows that respective antenna units 231-235 are connected to the telecommunications outlets 211-215 on each floor of the building, and that at the location 180 the fibres 201-205 connect to a patch panel 240 via respective patch panel connectors 241-5. The patch panel 240 is a connector bank joining the fibres in the vertical risers with the fibres in the room. This patch panel allows connections to be made as needed. It connects via respective hub connectors 251-255 to a hub 250, having five inlet/outlet points, and the hub 250 is connected to receive input signals from, and to provide output signals to first and second signal units 260, 270. The patch panel connectors 241-5 and the hub connectors 251-255 are tunable connectors embodying the invention.

In this embodiment, the first signal unit 260 is an Access Point providing digital signals into the optical system after modulating on a carrier, and the second signal unit 270 is be a mobile telephone base station. The signal units 260, 270 typically allow both signal emission and reception.

It should be understood that this drawing shows only the downlink direction—i.e. signals from the signal units 260, 270 to the antenna units. For the uplink direction of transmission, tunable connectors are used at the antenna unit end of the system.

Again, in this embodiment, the fibres 201-5 are downlink fibres and a second set of fibres (not shown) provides the uplink. In other embodiments the same fibres are used to carry both signal directions.

In use mode mixing will occur at connectors between the input modal power distribution in the fibre before the connectors and the output fibre. If the input and output fibre are identical and are perfectly aligned, then no mode mixing occurs. However, this is very unlikely and in all normal cases there will be some form of mixing. Even if the input modal power distribution is a good one for transmission, then it can be degraded by the mode mixing. This means that the modes are likely to travel at larger relative phase/group velocities than optimum and this gives rise to pulse spreading (for digital signals) or frequency nulls (for RoF). The closer the degradation is to the start of the link, the greater the fibre distance the velocity mismatches will have to take effect. So, close to the end it is less significant but near the beginning it is a problem. Hence the tunable connectors have the greatest advantage if near the start of the transmission path.

For signals transferred by the fibre towards the antenna unit, “normal” connectors near the antenna unit end will cause mode mixing; however as there is only a short distance of fibre after the connector, so signal degradation from dispersion only has a small effect. Equally from a practical perspective, it may be easier to find the optimum alignment of the keyed connector at the start of the link, rather than part way along the link as it is easier to monitor the performance at that point.

Signals conveyed by the main optical fibres 201-205 are subject to the problems discussed above, and it has therefore been found significant to ensure that optimal signal transfer conditions exist. As noted above, the inventors have established that by providing correctly controlled launch conditions it is possible to transfer signals modulated on an rf carrier, which means that both amplitude and phase information are derivable in the output.

In some embodiments of the connector a fibre end face for making physical contact with a counterpart fibre is flat—i.e. planar. In others an end face is domed; in yet others angled faces are provided.

Embodiments of the invention have now been described, however these are not restrictive. The skilled person will be aware of many changes to these embodiments that remain within the scope of the invention.

1. A method of operating a multimode optical fibre transmission system, comprising selecting a launch condition to provide a desired performance at an output of the transmission system.

2. A method according to claim 1, in which the launch condition comprises a launch that is mode-selective so that at least one r.f. carrier-based signal is carried by fibre.

3. A method according to claim 2, wherein a signal carried by the fibre comprises plural r.f. carrier-based signals.

4. A method according to claim 1, wherein light is launched into the fibre at an angle offset from the fibre axis, whereby reflection into a source laser, and hence laser noise, is reduced.

5. A method of coupling optical radiation into a multimode optical fibre portion, the method comprising varying at least one of lateral axial offset, angular axial offset and launch polarisation to influence the optical modes coupled into the optical fibre portion, so as to improve transmission through the optical fibre portion.

6. A method as claimed in claim 5, for use in an optical fibre system in which the optical fibre portion has a proximal end and a distal end, wherein light is launched into the proximal end and the distal end is connected to a first end of a further optical fibre portion, the method further comprising detecting optical output from a second end of the further optical fibre portion, and implementing the varying step to improve the detected optical output.

7. A method according to claim 5, in which the optical radiation is coupled from a laser into the multimode optical fibre portion.

8. A connector device including first and second parts, each part configured to receive respective end regions of portions of optical fibre to be connected together by the connector device wherein the connector device is configured to enable connection between a body portion of the first part and a body portion of the second part in at least two different angular dispositions.

9. A connector device as in claim 8, in which the end face at least one fibre is one of flat, and angle polished, physical contact connectors.

10. A method of setting up an optical fibre transmission system, the method comprising
providing a connector device for coupling together a first portion of fibre to a second portion of fibre, wherein at least one of the first portion and second portion is multimode fibre, wherein the connector device includes first and second parts, an end of the first portion of fibre being housed in the first part and an end of the second portion of fibre being housed in the second part,
engaging together the first and second connector parts;
launching a signal into one of said first and second fibre portions; and
monitoring the signal received at the other of the first and second fibres with the connector parts in mutually different angular dispositions.

11. A method of setting up an optical fibre transmission system, the method comprising
varying the launch of an input signal beam into a multimode fibre; and
monitoring the signal received from an output end of the multimode fibre.
